(19) United States
(12) Patent Application Publication
(10) Pub. No.: US 2008/0304844 A1
(43) Pub. Date: Dec. 11, 2008

(54) LIGHT SCANNING UNIT AND IMAGE FORMING APPARATUS EMPLOYING THE SAME

(75) Inventor: DOO-JIN BANG, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/026,043

(22) Filed: Feb. 5, 2008

(30) Foreign Application Priority Data
Jun. 11, 2007 (KR) 2007-56930

(51) Int. Cl. G03G 15/043

(52) U.S. Cl. 399/51

(57) ABSTRACT

A light scanning unit of an image forming apparatus, the light scanning unit including: a base frame comprising a metal material to prevent the base frame from expanding and/or contracting due to an ambient temperature change; one or more mounting members provided in the base frame; and one or more optical elements mounted on the base frame by the one or more mounting members, the one or more optical elements generating and/or scanning a light beam.

### CROSS-REFERENCE TO RELATED APPLICATION

This application claims the benefit of Korean Application No. 2007-56930, filed Jun. 11, 2007 in the Korean Intellectual Property Office, the disclosure of which is incorporated herein by reference.

### BACKGROUND OF THE INVENTION

1. Field of the Invention

Aspects of the present invention relate to a light scanning unit that scans a light beam on to a photosensitive medium and an image forming apparatus employing the same, and more particularly, to a light scanning unit that reduces deformation due to an ambient temperature rise and an image forming apparatus employing the same.

2. Description of the Related Art

Generally, a light scanning unit is employed in an image forming apparatus (such as a laser printer, a digital photocopier, a facsimile, etc.). The light scanning unit forms a latent image on a photosensitive medium through a main scanning of a beam deflector and a sub-scanning by a rotation of the photosensitive medium.

An example of an image forming apparatus employing the light scanning unit is a tandem color image forming apparatus. The tandem color image forming apparatus includes a plurality of light scanning units to form a latent image for each color, and a plurality of developing units to develop an image for each color. Here, a quality of the image is determined by a color registration among color latent images formed on the photosensitive medium by the respective light scanning units.

However, even if the color registration is fine-tuned during a manufacturing of the image forming apparatus, the color registration becomes minutely distorted due to a change of internal temperature while the image forming apparatus is used. Specifically, as the internal temperature of the image forming apparatus rises during use, a housing of the light scanning unit contracts or expands, thereby changing an arrangement of components (e.g., a beam deflector and an f-θ lens) related to the color registration within the housing.

To prevent the foregoing problem, the image forming apparatus performs an auto registration, which automatically tunes the color registration under a particular condition. If the auto registration is performed frequently, standby time increases and a developer is consumed and wasted. To reduce a number of auto registrations performed by the image forming apparatus, it is necessary to find a configuration, material, and/or method that are less sensitive to a change in temperature within the image forming apparatus while the image forming apparatus is in use.

FIG. 1 is a schematic cross-sectional view of a conventional light scanning unit. Referring to FIG. 1, the conventional light scanning unit includes a housing 1 and optical elements 3, 5, and 7 that are provided in the housing 1.

The housing 1 includes a plastic mold material with an added reinforcement (such as glass fiber or mineral powder). The added reinforcement may allow the image forming apparatus to be less sensitive to environmental changes, such as a rise in ambient temperature. However, the conventional image forming apparatus is still affected by the environmental changes. The optical elements include a beam deflector 3, an f-θ lens 5 and a reflection mirror 7 provided in the housing 1.

The housing 1 is manufactured by a molding. A plastic resin including the reinforcement is the basic material of the housing 1, and flows in a direction of a length L of the housing 1 during a manufacturing process of the housing 1. A height h of the housing 1 is perpendicular to the flow direction of the plastic resin.

As an example, the housing 1 includes poly carbonate with glass fiber added. The length L of the housing 1 is 200 mm and the height h thereof is 40 mm. If the temperature change is approximately 30° C., the housing 1 deforms in the height h direction by approximately 0.06 mm to 0.09 mm and in the length L direction by approximately 0.12 mm to 0.19 mm. Such a deformation affects the color registration and, therefore, requires frequent auto registration. Furthermore, opposite ends of the housing 1 in the lengthwise direction become crooked thereby distorting an optical axis and degrading the quality of the image.

### SUMMARY OF THE INVENTION

Aspects of the present invention provide a light scanning unit that minimizes deformation due to change in ambient temperature while being used, and an image forming apparatus employing the same.

According to an aspect of the present invention, there is provided a light scanning unit of an image forming apparatus, the light scanning unit including: a base frame including a metal material to prevent the base frame from expanding and/or contracting due to an ambient temperature change; one or more mounting members provided in the base frame; and one or more optical elements mounted on the base frame by the one or more mounting members, the one or more optical elements generating and/or scanning a light beam.

The one or more mounting members may be provided in the base frame by outsert injection molding, press fitting, and/or adhesive bonding.

The one or more optical elements may include: a beam deflector to deflect and to scan the light beam emitted by a light source onto a photosensitive medium of the image forming apparatus; and an f-θ lens to form an image of the light beam deflected by the beam deflector onto the photosensitive medium.

The light scanning unit may further include a cover member that is coupled to the base frame, the cover member including a light-emitting window through which the light beam scanned by the one or more optical elements is emitted.

According to another aspect of the present invention, there is provided an image forming apparatus, including: a photosensitive medium on which a latent image is formed; a charging member to charge the photosensitive medium; a light scanning unit to expose the photosensitive medium and to form the latent image thereon, the light scanning unit including: a base frame including a metal material to prevent the base frame from expanding and/or contracting due to an ambient temperature change, one or more mounting members provided in the base frame, and one or more optical elements mounted on the base frame by the one or more mounting members, the one or more optical elements generating and/or scanning a light beam to form the latent image; a developing unit to form a visible image corresponding to the latent image onto the photosensitive medium; a transfer unit to transfer the image formed by the developing unit onto a printable medium; and a fusing unit to fuse the image transferred to the printable medium.

The one or more mounting members may be provided in the base frame by outsert injection molding, press fitting, and/or adhesive bonding.

The one or more optical elements may include: a beam deflector to deflect and to scan the light beam emitted by a light source onto the photosensitive medium; and an f-θ lens to form an image of the light beam deflected by the beam deflector onto the photosensitive medium.

The light scanning unit may further include a cover member that is coupled to the base frame, and has a light-emitting window to emit the light beam scanned by the one or more optical elements.

According to another aspect of the present invention, there is provided a light scanning unit of an image forming apparatus, the light scanning unit including: a base frame comprising a metal material to prevent the base frame from expanding and/or contracting due to an ambient temperature change.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic cross-sectional view of a conventional light scanning unit;

FIG. 2 is a schematic cross-sectional view of a light scanning unit according to an embodiment of the present invention; and

FIG. 3 is a schematic cross-sectional view of an image forming apparatus according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

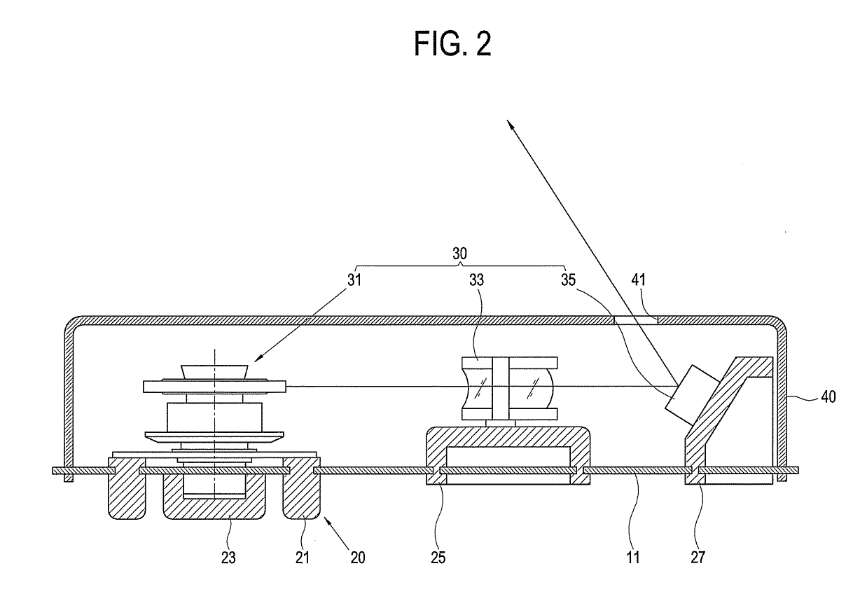

FIG. 2 is a schematic cross-sectional view of a light scanning unit according to an embodiment of the present invention. Referring to FIG. 2, the light scanning unit includes a base frame 11, one or more mounting members 20 provided in the base frame 11, and one or more optical elements 30 mounted on the base frame 11 by the one or more mounting members 20.

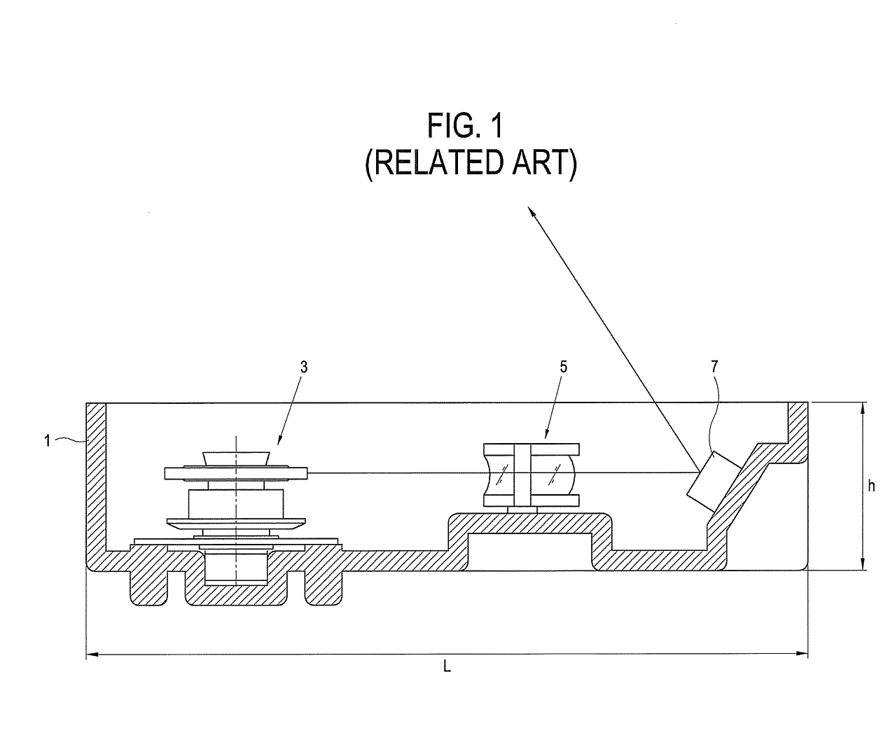

According to an aspect of the present invention, the base frame 11 includes a metal material (e.g., a cold rolled steel sheet). Furthermore, the base frame 11 is formed by a press processing (as shown in FIG. 2). A thermal expansion coefficient of the base frame 11 is approximately 5×10⁻⁶ μm/m° C., which is approximately 1/10 the value of the conventional housing 1 illustrated in FIG. 1. Thus, even a temperature change of 30° C. does not deform the base frame 11. Accordingly, an installed position of the base frame 11 is not changed by rising temperature while the light scanning unit is used.

The one or more mounting members 20 enable the one or more optical elements 30 to be provided on the base frame 11. The one or more mounting members 20 may have a variety of configurations according to a type of the one or more optical elements 30. Therefore, the one or more mounting members 20 may be made to be handled without difficulty. Further, the sizes and/or shapes of the one or more mounting members 20 may be determined such that the one or more optical elements 30 can be mounted in a precise optical arrangement. Thus, the sizes and/or shapes of the one or more mounting members 20 may be corrected without difficulty. To satisfy such requirements, the one or more mounting members 20 may include plastic.

The one or more mounting members 20 may be provided in the base frame 11 by outsert molding (such as mounting members 21, 25 and 27). Also, the one or more mounting members 20 may be coupled with the one or more optical elements 30 by press fitting (such as mounting member 23), leaving the base frame 11 therebetween so that the one or more optical elements 30 are mounted on the base frame 11. Furthermore, the one or more mounting members 20 may be provided in the base frame 11 to secure the one or more optical elements 30 by adhesive bonding.

If the one or more mounting members 20 include plastic, as described above, thermal deformation of the one or more mounting members 20 may slightly occur due to an ambient temperature rise. Meanwhile, the one or more mounting members 20 are provided to support the respective optical elements 30 on the base frame 11. According to an aspect of the present invention, a width and a height of the respective mounting members 20 may be drastically less than those of a conventional housing. Thus, if, for example, the one or more mounting members 20 includes plastic, the light scanning unit according to aspects of the present invention has approximately ⅙ to 1/10 of a size deformation as compared to that of the conventional light scanning unit illustrated in FIG. 1.

Thus, the optical alignment of the one or more optical members 30 is maintained while the light scanning unit is used, thereby preventing an increase of unnecessary standby time and developer consumption due to frequent auto registration.

The one or more optical elements 30 include a beam deflector 31 that deflects and scans a light beam to a photosensitive medium (not shown), and an f-θ lens 33 that forms an image on the photosensitive medium with the light beam deflected by the beam deflector 31. The beam deflector 31 is secured on the base frame 11 by a first mounting member 21 and a second mounting member 23. As described above, the first mounting member 21 is provided on the base frame 11 by the outsert method, and attaches a part of the beam deflector 31 to the base frame 11. The second mounting member 23 is coupled with another part of the beam deflector 31 (e.g., a driving source) by press fitting to attach the other part of the beam deflector 31 to the base frame 11. However, it is understood that according to other aspects, other methods may be used to provide the mounting members 21 and 23 on the base frame 11, and/or to attach the beam deflector 31 to the mounting member 21 and 23.

The one or more optical elements 30 further include a light source (not shown) to emit a light beam, and a collimating lens (not shown) and a cylindrical lens (not shown) provided on an optical path between the light source and the beam deflector 31. The light source, the collimating lens, and the cylindrical lens are provided on the base frame 11 by the one or more mounting members 20.

The f-θ lens 33 adjusts astigmatism of the light beam deflected by the beam deflector 31 and corrects the scanning line to maintain a uniform line and a uniform angle. As shown in FIG. 2, the f-θ lens 33 may include a single lens. However, it is understood that according to other aspects, two or more lenses may be provided. The f-θ lens 33 is supported on the base frame 11 by the third mounting member 25 provided in the base frame 11 by the outsert method. However, it is understood that according to other aspects, other methods may be used to provide the mounting member 25 on the base frame 11, and/or to attach the f-θ lens 33 to the mounting member 25.

The one or more optical elements 30 may further include a reflection mirror 35 that changes a proceeding direction of the scanning line passing through the f-θ lens 33. The reflection mirror 35 may be supported on the base frame 11 by the fourth mounting member 27 provided in the base frame 11 by the outsert method. However, it is understood that according to other aspects, other methods may be used to provide the mounting member 27 on the base frame 11, and/or to attach the reflection mirror 35 to the mounting member 27.

The light scanning unit may further include a cover member 40 that is coupled to the base frame 11. The cover member 40 includes a light-emitting window 41 through which the light beam is emitted to an outside of the light scanning unit from the one or more optical elements 30. The light-emitting window 41 may have an opening as shown in FIG. 2, or may include an opening having a transparent member provided therein. If the light scanning unit includes the cover member 40, the one or more optical elements 30 are prevented from external contaminant and noise due generated by the light scanning unit may be reduced.

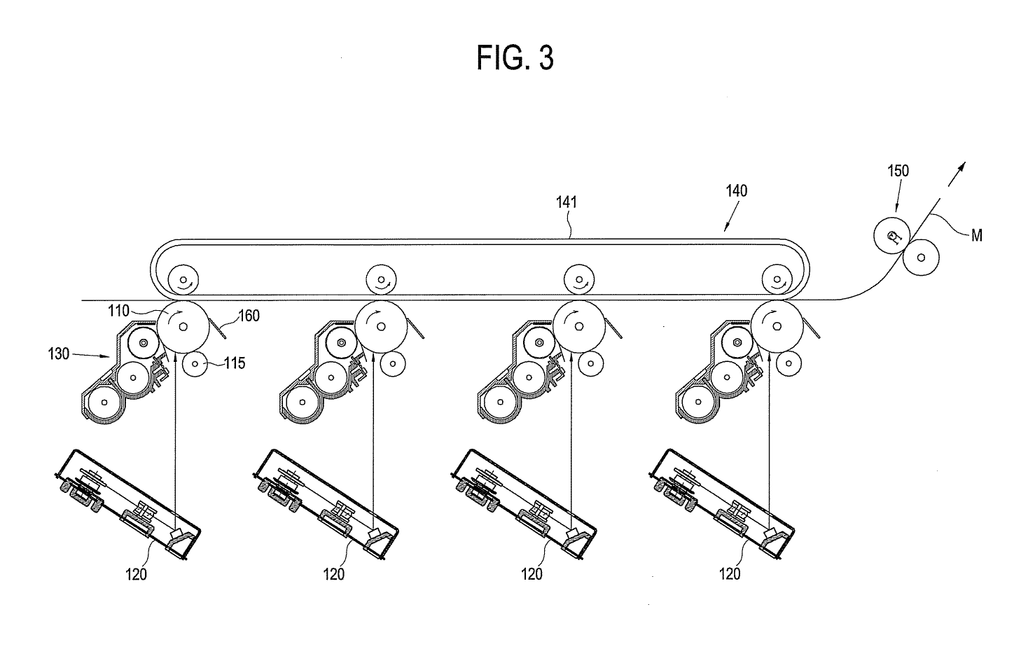

FIG. 3 is a schematic cross-sectional view of an image forming apparatus according to an embodiment of the present invention. Referring to FIG. 3, the image forming apparatus includes a photosensitive medium 110, a charging member 115 that charges the photosensitive medium 110, a light scanning unit 120 that forms a latent image on the photosensitive medium 110, a developing unit 130 that develops a visible image from the electrostatic latent image formed on the photosensitive medium 110, a transfer unit 140 that transfers the visible image formed by the developing unit 130 onto a print medium M, and a fusing unit 150 that fuses the visible image transferred onto the print medium M. The image forming apparatus may further include a cleaning unit 160 that removes any toner remaining on the photosensitive medium 110 after the visible image is transferred onto the print medium M.

FIG. 3 illustrates a tandem color image forming apparatus in which the photosensitive medium 110, the charging member 115, the light scanning unit 120, and the developing unit 130 are provided for each color along a feeding path of the print medium M.

The light scanning unit 120 scans a light beam on to the photosensitive media 110 provided for each color, and forms a latent image on the photosensitive media 110 charged to have a predetermined electric potential by the charging member 115. The light scanning unit 120 is provided according to aspects of the present invention as described with reference to FIG. 2. Thus, the detailed description thereof will not be repeated here.

The developing unit 130 supplies a toner to the photosensitive medium 110 and forms a visible image corresponding to the latent image.

The transfer unit 140 is provided to face the plurality of photosensitive media 110, such that the print medium M is fed along the feeding path therebetween. Accordingly, the transfer unit 140 transfers the toner image formed on the photosensitive media 110 to the supplied print medium M. The transfer unit 140 includes a transfer belt 141 facing the plurality of photosensitive media 110.

The fusing unit 150 presses and heats the print medium M and fuses the image transferred on to the print medium M thereto.

As described above, the light scanning unit according to aspects of the present invention includes one or more optical elements arranged by using a mounting member and a base frame made of a metal material. Accordingly, thermal deformation of the base frame and the mounting member due to a rise in ambient temperature rise while the light scanning unit is used is reduced. Thus, the optical alignment of the one or more optical members is maintained while being used.

Moreover, as described above, the image forming apparatus employing the light scanning unit according to aspects of the present invention may reduce a required number of auto registrations by ensuring the optical alignment of the one or more optical elements of the light scanning unit. Thus, the unnecessary standby time and/or the developer consumption due to the auto registration may be reduced.

Although a few exemplary embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A light scanning unit of an image forming apparatus, the light scanning unit comprising:
a base frame comprising a metal material to prevent the base frame from expanding and/or contracting due to an ambient temperature change;
one or more mounting members provided in the base frame; and
one or more optical elements mounted on the base frame by the one or more mounting members, the one or more optical elements generating and/or scanning a light beam.

2. The light scanning unit as claimed in claim 1, wherein the one or more mounting members comprise a plastic material to enable a size and/or a shape adjustment of the one or more mounting materials according to an arrangement of the one or more optical elements.

3. The light scanning unit as claimed in claim 1, wherein the one or more mounting members are provided in the base frame by outsert injection molding, press fitting, and/or adhesive bonding.

4. The light scanning unit as claimed in claim 1, wherein the one or more optical elements comprise:
a beam deflector to deflect and to scan the light beam emitted by a light source onto a photosensitive medium of the image forming apparatus; and
an f-θ lens to form an image of the light beam deflected by the beam deflector onto the photosensitive medium.

5. The light scanning unit as claimed in claim 1, further comprising a cover member that is coupled to the base frame, the cover member comprising a light-emitting window through which the light beam scanned by the one or more optical elements is emitted.

6. The light scanning unit as claimed in claim 4, wherein the beam deflector is mounted on the base frame by a first mounting member, and the f-θ lens is mounted on the base frame by a second mounting member.

7. The light scanning unit as claimed in claim 4, wherein the beam deflector is mounted on the base frame by a first mounting member and a second mounting member.

8. The light scanning unit as claimed in claim 4, wherein the one or more optical elements further comprise:
a reflection mirror to change a direction of the light beam from the f-θ lens such that the light beam is directed to the photosensitive medium.

9. The light scanning unit as claimed in claim 7, wherein:
the one or more optical elements further comprise a reflection mirror to change a direction of the light beam from the f-θ lens such that the light beam is directed to the photosensitive medium; and
the reflection mirror is mounted on the base frame by a third mounting member.

10. The light scanning unit as claimed in claim 4, wherein the one or more optical elements further comprise:
a collimating lens and a cylindrical lens provided on an optical path between the light source and the beam deflector to direct the light beam to the beam deflector.

11. An image forming apparatus, comprising:
a photosensitive medium on which a latent image is formed;
a charging member to charge the photosensitive medium;
a light scanning unit to expose the photosensitive medium and to form the latent image thereon, the light scanning unit comprising:
a base frame comprising a metal material to prevent the base frame from expanding and/or contracting due to an ambient temperature change,
one or more mounting members provided in the base frame, and
one or more optical elements mounted on the base frame by the one or more mounting members, the one or more optical elements generating and/or scanning a light beam to form the latent image;
a developing unit to form a visible image corresponding to the latent image onto the photosensitive medium;
a transfer unit to transfer the image formed by the developing unit onto a print medium; and
a fusing unit to fuse the image transferred to the print medium.

12. The image forming apparatus as claimed in claim 11, wherein the one or more mounting members are provided in the base frame by outsert injection molding, press fitting, and/or adhesive bonding.

13. The image forming apparatus as claimed in claim 11, wherein the one or more optical elements comprise:
a beam deflector to deflect and to scan the light beam emitted by a light source onto the photosensitive medium; and
an f-θ lens to form an image of the light beam deflected by the beam deflector onto the photosensitive medium.

14. The image forming apparatus as claimed in claim 11, wherein the light scanning unit further comprises a cover member that is coupled to the base frame, the cover member comprising a light-emitting window to emit the light beam scanned by the one or more optical elements.

15. The light scanning unit as claimed in claim 11, wherein the one or more mounting members comprise a plastic material to enable a size and/or a shape adjustment of the one or more mounting materials according to an arrangement of the one or more optical elements.

16. The light scanning unit as claimed in claim 13, wherein the beam deflector is mounted on the base frame by a first mounting member, and the f-θ lens is mounted on the base frame by a second mounting member.

17. The light scanning unit as claimed in claim 13, wherein the beam deflector is mounted on the base frame by a first mounting member and a second mounting member.

18. A light scanning unit of an image forming apparatus, the light scanning unit comprising:
a base frame comprising a metal material to prevent the base frame from expanding and/or contracting due to an ambient temperature change.

19. The light scanning unit as claimed in claim 18, further comprising:
one or more mounting members provided in the base frame; and
one or more optical elements mounted on the base frame by the one or more mounting members, the one or more optical elements generating and/or scanning a light beam.

20. The light scanning unit as claimed in claim 19, wherein the one or more mounting members comprise a plastic material to enable a size and/or a shape adjustment of the one or more mounting materials according to an arrangement of the one or more optical elements.
